(19) United States
(12) Patent Application Publication
(10) Pub. No.: US 2024/0077592 A1
(43) Pub. Date: Mar. 7, 2024

(54) CARRIER MODULATION RANGING USING SPADS

(71) Applicant: STMicroelectronics (Research & Development) Limited, Marlow (GB)

(72) Inventor: John Kevin Moore, Edinburgh (GB)

(21) Appl. No.: 17/939,471

(22) Filed: Sep. 7, 2022

(51) Int. Cl. G01S 7/4861; G01S 7/4865; G01S 17/10

(52) U.S. Cl. CPC G01S 7/4861; G01S 7/4865; G01S 17/10

(57) ABSTRACT

An optical ranging system includes: a first phase-locked loop (PLL) configured to generate a first frequency signal and a second frequency signal; a second PLL configured to generate a third frequency signal based on a control signal that is formed using the first frequency signal; an optical source coupled to the second PLL, where an intensity of an optical signal emitted by the optical source is configured to be modulated in accordance with the third frequency signal; a first single-photon avalanche diode (SPAD) configured to receive a reflected optical signal; a time-to-digital converter (TDC) coupled to the first SPAD, where the TDC is configured to generate digital samples by sampling an output signal of the first SPAD under control of the second frequency signal; a reference signal generator configured to generate a reference signal; and a mixer configured to mix the reference signal and the digital samples from the TDC.

### TECHNICAL FIELD

The present invention relates generally to systems and methods for optical ranging.

### BACKGROUND

Optical ranging systems, such as Light Detection and Ranging (LiDAR) system or other Time-of-Flight (ToF) systems, are used in a wide variety of applications, such as autonomous driving systems, gesture recognition, 3D mapping, geological survey, as so on.

Many different methods have been proposed and trialed for optical ranging systems. These systems, however, all have trade-offs in performance. For example, single-photon avalanche diode (SPAD) based direct ToF (dToF) systems rely on pulsed optical signal with very high peak power, which may require expensive optical source such as vertical-cavity surface-emitting laser (VCSEL). The performance of the dToF system may suffer due to the total optical energy output being limited by the pulse duty cycle and the peak optical power that can be emitted safely from the optical source. Histogram storage and processing for dToF systems is memory and power intensive. As another example, indirect ToF (iToF) systems rely on discrete frequency steps, and as a result, multiple target extraction is challenging for iToF systems. Other challenges for iToF systems include optical crosstalk and limited maximum range. As yet another example, Frequency-Modulated Continuous Wave (FMCW) optical ranging systems rely on the use optical interferometers to combine reference and return optical path to allow range extraction. Integration of FMCW optical ranging systems can be complex and expensive. There is a need in the art for optical ranging systems that achieve improved performance, are easier to integrate, and have lower cost.

### SUMMARY

In accordance with an embodiment, an optical ranging system includes: a first phase-locked loop (PLL) configured to generate a first frequency signal and a second frequency signal; a second PLL configured to generate a third frequency signal based on a control signal, wherein the control signal is formed using the first frequency signal; an optical source coupled to the second PLL, wherein an intensity of an optical signal emitted by the optical source is configured to be modulated in accordance with the third frequency signal; a first single-photon avalanche diode (SPAD) configured to receive a reflected optical signal; a time-to-digital converter (TDC) coupled to the first SPAD, wherein the TDC is configured to generate digital samples by sampling an output signal of the first SPAD under control of the second frequency signal; a reference signal generator configured to generate a reference signal; and a mixer configured to mix the reference signal and the digital samples from the TDC.

In accordance with an embodiment, an optical ranging system includes: an optical source configured to emit an optical signal, wherein an intensity of the optical signal is configured to be modulated by a chirp signal; a single-photon avalanche diode (SPAD) configured to receive a reflected optical signal; a time-to-digital converter (TDC) coupled to the SPAD, wherein the TDC is configured to generate first digital samples by sampling an output signal of the SPAD, wherein the first digital samples have a first sampling rate; a reference signal generator configured to generate a reference signal that corresponds to the chirp signal sampled at the first sampling rate; and a mixer configured to mix the reference signal and the first digital samples from the TDC.

In accordance with an embodiment, a method of ranging using an optical ranging system includes: emitting an optical signal, wherein an intensity of the optical signal is modulated by a chirp signal during the emitting; sensing a reflected optical signal using a single-photon avalanche diode (SPAD); generating digital samples by sampling, at a first sampling rate, an output signal of the SPAD using a time-to-digital converter (TDC); and mixing, using a mixer, the digital samples from the TDC with a reference signal that corresponds to the chirp signal sampled at the first sampling rate.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of an optical ranging system, in an embodiment;

FIG. 2 illustrates chirp signals used in the optical ranging system of FIG. 1, in an embodiment;

FIG. 3 illustrates the frequency components of the modulated optical signal of the optical ranging system of FIG. 1, in an embodiment;

FIG. 4A illustrates a time-to-delay converter (TDC), in an embodiment;

FIG. 4B illustrates a timing diagram for the TDC of FIG. 4A, in an embodiment;

FIG. 5A illustrates a time-to-delay converter (TDC), in another embodiment;

FIG. 5B illustrates a timing diagram for the TDC of FIG. 5A, in an embodiment;

FIG. 6 illustrates the signal processing of the mixer of the optical ranging system of FIG. 1, in an embodiment;

FIG. 7 illustrates the frequency analysis performed by the optical ranging system of FIG. 1, in an embodiment;

FIG. 8 illustrates the performance of the optical ranging system of FIG. 1, in an embodiment;

FIG. 9 illustrates a block diagram of an optical ranging system, in another embodiment;

FIG. 10 illustrates a block diagram of an optical ranging system, in yet another embodiment; and

FIG. 11 illustrates a flow chart of a method of ranging using an optical ranging system, in some embodiments.

### DETAILED DESCRIPTION OF ILLUSTRATIVE EXAMPLES

The making and using of the presently disclosed examples are discussed in detail below. It should be appreciated, however, that the present invention provides many applicable inventive concepts that can be embodied in a wide variety of specific contexts. The specific examples discussed are merely illustrative of specific ways to make and use the invention, and do not limit the scope of the invention. Throughout the discussion herein, unless otherwise specified, the same or similar reference numerals in different figures refer to the same or similar component.

The present disclosure will be described with respect to examples in a specific context, namely an optical ranging system using an optical detector (e.g., a single-photon avalanche diode (SPAD)) and carrier modulation for the optical source (e.g., a laser diode) of the optical ranging system.

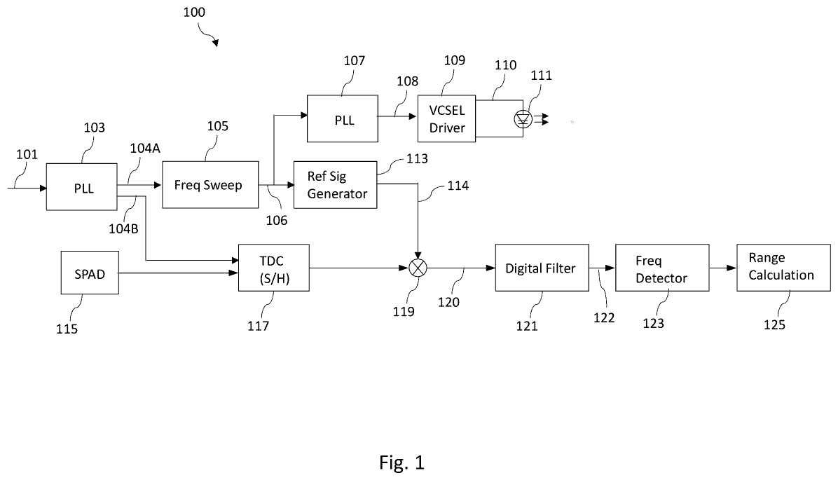

FIG. 1 illustrates a block diagram of an optical ranging system 100, in an embodiment. The optical ranging system 100 includes a first phase-locked lock loop (PLL) 103, a frequency sweep circuit 105, a second PLL 107, a driver circuit 109, an optical source 111, an optical detector 115 (e.g., a SPAD), a time-to-digital converter (TDC) 117, a reference signal generator 113, a mixer 119, a digital filter 121, a frequency detector 123, and a range calculation circuit 125. Note that for simplicity, not all features of the optical ranging system 100 are illustrated in FIG. 1. Operation of the optical ranging system 100 is discussed hereinafter.

The transmitter path of the optical ranging system 100 includes the first PLL 103, the frequency sweep circuit 105, the second PLL 107, the driver circuit 109, and the optical source 111. To emit an optical signal (e.g., a laser signal) by the optical source 111 (e.g., a laser diode), a control signal 101, which may be a digital control signal (e.g., a digital value) specifying an output frequency of the first PLL 103, is applied to an input terminal of the first PLL 103. In the illustrated embodiment, the first PLL 103 is a digital PLL, and is configured to generate a frequency signal 104A at an output terminal of the first PLL 103. The frequency signal 104A may be, e.g., a digital clock signal having a clock frequency specified by the control signal 101. In an embodiment, the digital control signal 101 has a fixed value, and as a result, the first PLL 103 generates a digital clock signal having a fixed clock frequency of, e.g., 1 GHz, as the frequency signal 104A. In the example of FIG. 1, the first PLL 103 also generates a frequency signal 104B (e.g., another digital clock signal) used in the receiver path, details of which are discussed hereinafter. Digital PLLs are known in the art, thus details are not discussed here.

For ease of discussion, the description of the operation of the optical ranging system 100 herein uses the example of 1 GHz as the frequency of the frequency signal 104A, and uses an over-sampling rate (OSR) of 8 in the discussion of the receiver path hereinafter. These numbers are illustrative and non-limiting. Skilled artisans will readily appreciate that other suitable frequencies, and other suitable OSRs, may also be used and are fully intended to be included within the scope of the present disclosure.

The frequency signal 104A (e.g., a 1 GHz digital clock signal) is sent to the frequency sweep circuit 105, which generates a digital ramp signal 106 that increases (e.g., sweeps) linearly from a first value to a second value in a pre-determined period of time. The digital ramp signal is used as the control signal for the second PLL 107. For example, the digital ramp signal 106 may have 1 giga discrete values in a second, and adjacent ones of these discrete values are separated by a fixed step size. In other words, these discrete values increase linearly from the first value to the second value. When plotted in a graph, these discrete values are aligned along a straight line with a specific gradient, in some embodiments.

In the example of FIG. 1, the second PLL 107 is also a digital PLL. Since the control signal of the second PLL 107 is the digital ramp signal 106, the second PLL 107 generates a frequency signal 108 with a time-varying frequency. In the illustrated embodiments, the frequency signal 108 is a digital clock signal, and the frequency of the digital clock signal varies (e.g., increases) gradually and linearly from a first clock frequency to a second clock frequency. As an example, under the control of the digital ramp signal 106, the frequency of the frequency signal 108 (e.g., a digital clock signal) increases from 100 MHz to 1 GHz during a per-determined period of time (e.g., during a chirp period).

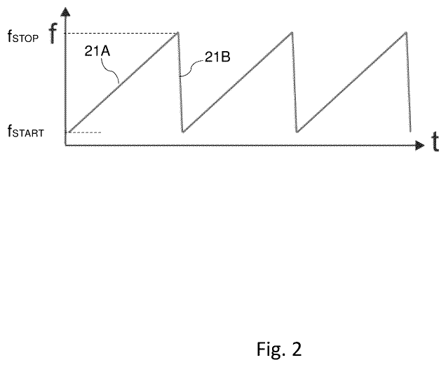

The frequency signal 108 is sent to the driver circuit 109, which generates a frequency signal 110 as the driving signal for the optical source 111. In the illustrated embodiment, the optical source 111 is a vertical-cavity surface-emitting laser (VCSEL) diode, and the driver circuit 109 is a VCSEL driver circuit. These are, of course, non-limiting examples, and other types of optical source and driver circuit may also be used. In some embodiments, the frequency signal 108 is a digital clock signal with a varying (e.g., linearly increasing) clock frequency, and the digital clock signal may have rectangular-shaped waveforms or trapezoid-shaped waveforms. After being processed (e.g., amplified, smoothed) by the driver circuit 109, the frequency signal 110 have waveforms that are, or closely resemble, sinusoidal waveforms, in some embodiments. Skilled artisans will readily appreciate that a sinusoidal frequency signal with linearly varying (e.g., increasing) frequency is also referred to as a chirp signal. Therefore, the frequency signal 110 is also referred to as a chirp signal 110 in the discussion here. Chirp signals are illustrated in FIG. 2.

Referring temporarily to FIG. 2, which illustrates chirp signals used in the optical ranging system 100 of FIG. 1, in an embodiment. FIG. 2 shows three identical frames of a signal 21, where each frame includes a chirp signal 21A (also referred to as a frequency ramp signal), with the frequency of the chirp signal 21A changes (e.g., increases) linearly from a first frequency f_{START} to a second frequency f_{STOP} in a period of time (may also be referred to as a chirp period), as illustrated in FIG. 2. The chirp signal 21A in FIG. 2 corresponds to the chirp signal 110 in FIG. 1. Within each frame, a fly-back signal 21B is generated after the chirp signal 21A in a short period of time (referred to as a fly-back period), during which the frequency of the signal 21 drops quickly from f_{STOP} back to f_{START}. In some embodiments, transmission of the optical signal may be disabled during the fly-back periods. The operation of the optical ranging system 100 discussed herein is performed for the chirp period in each frame of the signal 21, in some embodiments. In the example of FIG. 2, the chirp signal 21A is shown as having an increasing frequency, and the fly-back signal 21B is shown as having a decreasing frequency. In other embodiments, the chirp signal 21A has a decreasing (e.g., linearly decreasing) frequency, and the fly-back signal 21B has an increasing frequency.

Note that in the illustrated embodiment of FIG. 1, the chirp signal 110 is used to modulate (e.g., change) the intensity (e.g., brightness) of the optical signal emitted by the optical source 111. The frequency of the optical signal is not changed by the chirp signal 110. For example, if the optical source 111 emits a laser signal with a 940 nm wavelength, the chirp signal 110 is used to modulate the intensity of the laser signal but not the wavelength (or the bandwidth) of the laser signal. In other words, the wavelength (e.g., the color) of the optical signal is not changed, but its intensity is modulated by the chirp signal 110. Note that when the intensity of the light signal is being modulated (and when the receiver path of the optical ranging system 100 is calculating the distance of the target), the optical source 111 (e.g., the laser diode) stays in the ON state (e.g., is turned on and emitting the optical signal) during the chirp period. This is different from other ToF systems using a pulsed optical source, where the optical source is turned ON and OFF alternately (e.g., turned on for a first period of time, then turned off for a second period of time) to emit a pulsed optical signal. The disclosed method herein may advantageously reduce the peak-to-average power ratio of the optical source 111.

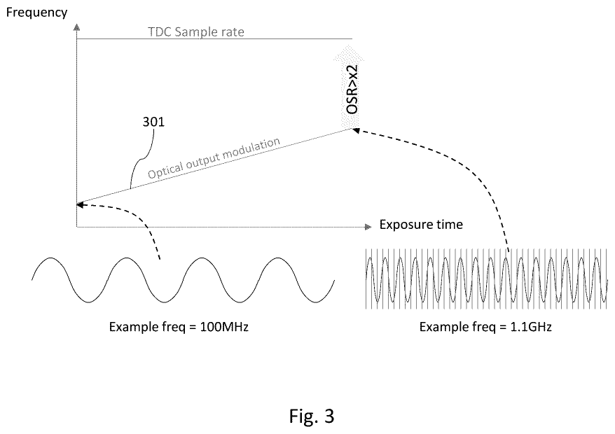

Denote the optical signal emitted by the optical source 111 without the modulation by the chirp signal 110 as L(t), and denote the chirp signal 110 as C(t), then the optical signal modulated by the chirp signal 110, denoted as ML(t), is given as ML(t)=L(t)*C(t). Skilled artisans will readily appreciate that multiplying a signal S(t) having a bandwidth W with a carrier signal sin(2πfₒt) shifts the center frequency of the signal S(t) to the carrier frequency fₒ without changing the bandwidth W of the signal S(t). Since the chirp signal C(t) is a sinusoidal signal with a linearly changing frequency, modulating the intensity of the optical signal L(t) by the chirp signal C(t) can be considered as changing (e.g., modulating) the carrier frequency of the optical signal L(t) from the first frequency f_{START} (see FIG. 2) to the second frequency f_{STOP} during a chirp period. The frequency components of the modulated optical signal ML(t) is illustrated in FIG. 3.

Referring temporarily to FIG. 3, which illustrates the frequency components of the modulated optical signal of the optical ranging system 100 of FIG. 1, in an embodiment. In the example of FIG. 3, the modulated optical signal ML(t) is a laser signal (e.g., having a wavelength of 940 nm) with its intensity modulated by the chirp signal 110, and the chirp signal 110 sweeps from 100 MHz to 1.1 GHz in a chirp period. The line 301 in FIG. 3 shows the frequency component of the modulated optical signal over a chirp period. In the example of FIG. 3, the frequency component of the modulated optical signal during a chirp period is contained within a frequency band of about 1 GHz (e.g., from 100 MHz to 1.1 GHz), which frequency band is due to the carrier frequency (e.g., the chirp frequency) changing over a chirp period. Therefore, according to Nyquist sampling theorem, a sampling rate (also referred to as sampling frequency) larger than 2 GHz should be able to sample the modulated signal of FIG. 3 without aliasing.

The limited frequency band for the modulated optical signal and the corresponding sampling frequency required allow for an all-digital receiver path to be used after the SPAD, which significantly lowers the complexity and cost of the optical ranging system 100. To illustrate the advantage, consider another optical ranging system where the frequency of the optical signal, instead of the carrier of the optical signal, is modulated. Frequency modulation may result in a very wide bandwidth for the frequency modulated optical signal, which would require an expensive high-speed analog-to-digital converter to sample the output of the SPAD. An alternative to avoid the high sampling rate due to the high bandwidth of frequency modulated optical signal is to use an optical interferometer to process the received (e.g., reflected) optical signal, and the output of the optical interferometer, which may have a narrow bandwidth, is then converted into digital samples for processing in digital domain. However, optical interferometer may be expensive and difficult to integrate into the optical ranging system. The present disclosure, by modulating the carrier frequency of the optical signal, instead of modulating the frequency of the optical signal itself, allows for lower sampling rate using less expensive hardware, and allows for mixing (e.g., down-conversion) of the digital samples from SPAD with a reference signal using a digital mixer (e.g., a multiplier). The simplified processing lowers system cost, and allows for easy integration. Details are discussed below.

Referring back to FIG. 1, the receiver path of the optical ranging system 100 and its operation are discussed hereinafter. The optical detector 115 receives the reflected optical signal from, e.g., a target. In the discussion herein, a SPAD is used as the optical detector 115, and therefore, the optical detector 115 may also be referred to SPAD 115 in the discussion herein, with the understanding that besides SPAD, the optical detector 115 may be any suitable optical detector.

The output of the SPAD 115 is sent to the TDC 117 and is sampled by the TDC 117 under the control of the control signal 104B. Note that the output of the SPAD 115 indicates avalanche current events caused by photons received by the SPAD 115. For example, the output of the SPAD 115 may stay at a logic low value (e.g., at a low voltage such as zero volt) when no photon is received, and when a photon received by the SPAD 115 causes an avalanche current, the output of the SPAD 115 turns into a logic high value (e.g., at a high voltage such as a supply voltage +V_{DD}). Therefore, the values of the digital samples generated by the TDC 117 may be zeros most of the time, with some ones interspersed in the zeros (e.g., when avalanche current happens).

In the examples of FIG. 1, the first PLL 103 provides the frequency signal 104B (e.g., a digital clock signal) to the TDC 117, and the frequency signal 104B is used to as a sampling clock to control the sampling of the output of the SPAD 115 by the TDC 117. In some embodiments, the frequency signal 104B is a single digital clock signal. In other embodiments, the frequency signal 104B is a plurality of digital clock signals having the same clock frequency but different phases, details are discussed below.

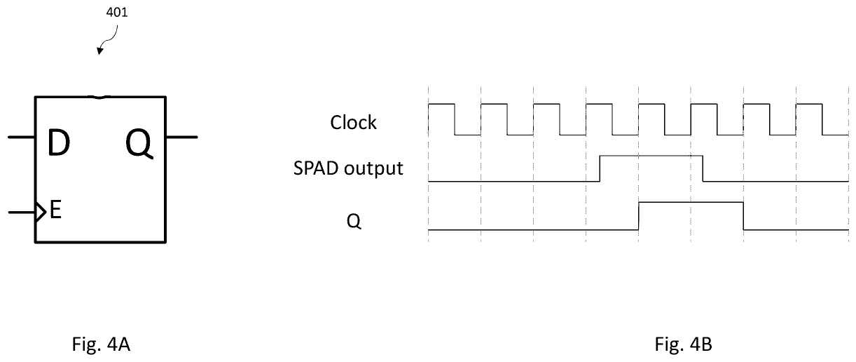

In an embodiment, the frequency signal 104B is a digital clock signal, and a clock frequency of the frequency signal 104B is an integer multiple N of the clock frequency of the frequency signal 104A. For example, the frequency signal 104A may be a 1 GHz digital clock signal, and the frequency signal 104B may be an 8 GHz digital clock signal (e.g., N=8). For the modulated optical signal in FIG. 3, which has frequency components in a frequency band of 1 GHz, the frequency signal 104B provides an oversampling rate (OSR) of 8. The integer multiple of 8 and the OSR of 8 are merely non-limiting examples, other suitable values are also possible and are fully intended to be included within the scope of the present disclosure. The TDC 117 for this embodiment may be a D flip-flop driven by, e.g., the 8 GHz digital clock signal provided by the frequency signal 104B. FIGS. 4A and 4B illustrate the TDC 117 and its timing diagram for this embodiment.

Referring temporarily to FIG. 4A, which shows a D flip-flop 401 that functions as the TDC 117 of FIG. 1. The output of the SPAD 115 is sent to the input terminal D of the D flip-flop 401, and the frequency signal 104B (e.g., an 8 GHz digital clock signal) is sent to the enable terminal E of the D flip-flop 401. The D flip-flop 401 latches the output of the SPAD 115 at the sampling frequency (e.g., 8 GHz) determined by the frequency signal 104B, and the output terminal Q of the D flip-flop 401 gives digital samples of the output of the SPAD 115 at the sampling frequency.

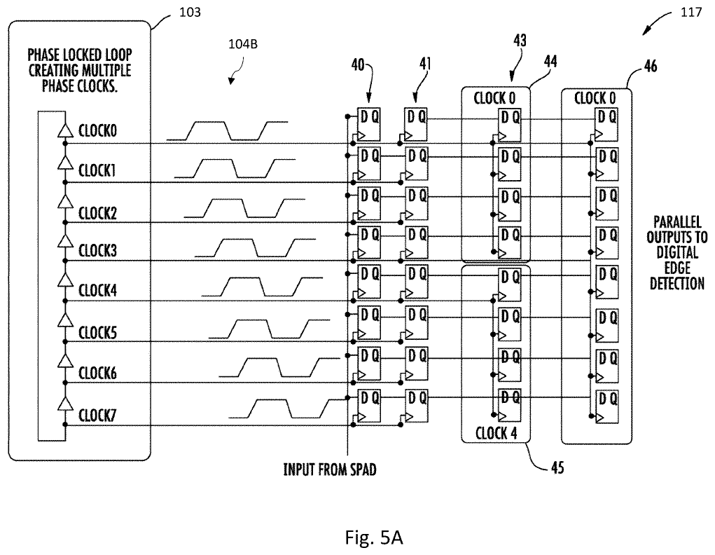

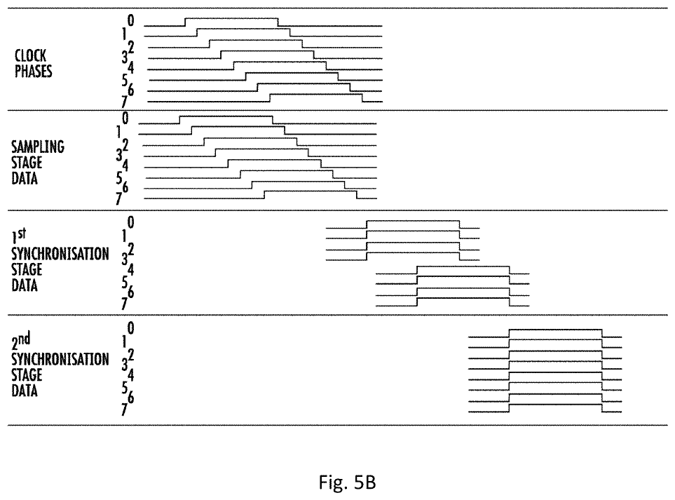

FIG. 4B shows the timing diagram of the D flip-flop 401. In FIG. 4B, the signal at the top is the clock signal (e.g., 104B) of the D flip-flop 401, the signal in the middle is the input of D flip flop 401 (which is the output of the SPAD 115), and signal at the bottom is the output of the D flip-flop 401. Using the D flip-flop 401 as the TDC 117 has the advantage of simple hardware design. However, if the sampling frequency is high, it may be difficult to drive the D flip-flop at a high sampling frequency. FIG. 5A shows another embodiment of the TDC 117, where a plurality of D flip-flops are used in multi sampling stages, and a plurality of sampling clock signals having the same sampling frequency but different phases are used to provide digital samples of the SPAD 115 at a high sampling rate.

Referring temporarily to FIG. 5A. which illustrates a plurality of clock signals labeled as CLOCK0, CLOCK1, . . . , and CLOCK 7. The plurality of clock signals correspond to the frequency signal 104B illustrated in FIG. 1. The plurality of clock signals are generated by the first PLL 103 of FIG. 1. The plurality of clock signals have the same frequency (e.g., 1 GHz), and adjacent clock signals (e.g., CLOCK0 and CLOCK1) have a timing offset (or equivalently, a phase offset) that is equal to, e.g., ⅛ of a clock cycle. The number of clock signals with different phases in FIG. 5A is eight, which is simply a non-limiting example. Other number of phases are also possible and are fully intended to be included within the scope of the present disclosure. Note that the first PLL 103 is illustrated in FIG. 5A for completeness, but is not part of the TDC 117.

As illustrated in FIG. 5A, the TDC 117 includes four sampling stages labeled as 40, 41, 43, and 46, where each of the sampling stages includes, e.g., eight D flip-flops. The D flip-flops in the sampling stage 40 are driven by respective clock signals of the frequency signal 104B, and sample the output of the SPAD 115. The D flip-flops in the re-sampling stage 41 are also driven by respective clock signals, and re-sample the outputs of the respective D flip-flops in the sampling stage 40. The re-sampling stage 41 may advantageously be included to re-sample the outputs of the sampling stage 40 under the same phases to help avoid metastable (mid-rail) conditions, such as when the digital signal goes high at the same time as a clock signal, for example. The re-sampled outputs from the re-sampling stage 41 are provided to a first synchronization stage 43, which is configured to synchronize a first subset of the outputs (e.g., the first four D-flip flop outputs) from the re-sampling stage 41 to a first one (e.g., CLOCK0) of the plurality of clock signals, and is configured to synchronize a second subset of the outputs (e.g., the last four D flip-flop outputs) from the re-sampling stage 41 to a second one (e.g., CLOCK4) of the plurality of clock signals.

Still referring to FIG. 5A, a second synchronization stage 46 is coupled to the first synchronization stage 43 and is configured to receive the synchronized outputs from the first synchronization stage 43, and synchronize all of the synchronized outputs from the first synchronization stage 43 to the first one (e.g., CLOCK0) of the plurality of clock signals. The synchronized outputs from the second synchronization stage 46 may be read out by a faster clock signal (e.g., an 8 GHz clock signal), and sent to a first input terminal of the mixer 119 as the output digital samples from the TDC 117. A TDC circuit same as or similar to the TDC 117 illustrated in FIG. 5A is disclosed in U.S. Pat. No. 10,067,224, which patent is incorporated herein by reference. In the discussion herein, the number of digital samples generated at the output of the TDC 117 per second is referred to as the sampling rate of the TDC 117, and the TDC is said to sample the output of the SPAD 115 at the sampling rate. Therefore, in the above discussed examples, the sampling rate of the TDC 117 is 8 giga samples per second, and the TDC 117 is said to sample the output of the SPAD 115 at a sampling rate of 8 GHz.

An example timing diagram for the TDC 117 of FIG. 5A is illustrated in FIG. 5B. In FIG. 5B, the signals labeled as CLOCK PHASES show the plurality of clock signals with different phases. The signals labeled as SAMPLING STAGE DATA show the output signals of the sampling stage 40 (or the re-sampling stage 41). The signals labeled as 1st SYNCHRONISATION STAGE DATA show the output signals of the first synchronization stage 43. The signals labeled as 2^{nd} SYNCHRONISATION STAGE DATA show the output signals of the second synchronization stage 46.

Referring back to FIG. 1, the reference signal generator 113 is coupled between the frequency sweep circuit 105 and a second input terminal of the mixer 119. The reference signal generator 113 is configured to generate a reference signal 114 using the digital ramp signal 106. In some embodiments, the reference signal 114 is a digital version of the chirp signal 110, and may be considered as digital samples of an ideal chirp signal (e.g., a sinusoidal signal with linearly increasing frequency between the first frequency f_{START} and the second frequency f_{STOP} in a chirp period). The reference signal 114 has a data rate that matches the data rate of the digital samples generated by the TDC 117. In the above examples, the sampling rate of the TDC 117 is 8 giga samples per second, then the reference signal 114 has a data rate of 8 giga samples per second (e.g., producing 8 giga digital values per second). In other words, the reference signal 114 may be conceptionally considered as digital samples of the chirp signal 110, sampled at the same sampling rate (e.g., 8 GHz) of the TDC 117.

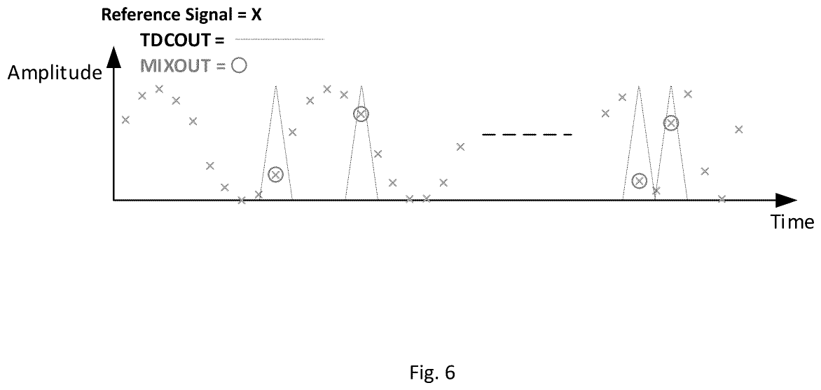

The mixer 119 is a digital multiplier, in the illustrated embodiment. The mixer 119 mixes (e.g., multiplies) the reference signal 114 with the digital samples from the TDC 117. The output signal 120 of the mixer 119 comprises a beat signal, where the frequency of the beat signal (referred to as the beat frequency) is proportional to the time-of-flight of the optical signal, or equivalently, the distance between the optical ranging system 100 and the target. The disclosed embodiment herein allows a digital multiplier to be used as the mixer 119 instead of using an analog mixer, which reduces component cost and allows higher level of integration of the optical ranging system 100. FIG. 6 shows the operation of the mixer 119.

Referring temporarily to FIG. 6, which illustrates the signal processing of the mixer 119, in an embodiment. In FIG. 6, the x-axis represents time, and the y-axis represents the output value of the mixer 119. In FIG. 6, the output of the TDC 117 is illustrated by the dashed line, and the peaks of the dashed line show some non-zero values (e.g., 1) at certain time instants that correspond to the discrete events of avalanche current in the SPAD 115. The reference signal 114 is illustrated by the “X” marker symbol, and the output signal 120 of the mixer 119 is illustrated by the “O” marker symbol.

Referring back to FIG. 1, note that the frequency of the beat signal is generally much lower (e.g., a beat frequency of less than 1 MHz) than that of the sampling frequency (e.g., 8 GHz) of the TDC 117. Therefore, the output of the mixer 119 is filtered by a digital filter 121 (e.g., a low-pass digital filter) to filter out out-of-band noise. After the filtering, a sample rate reduction process may be performed to reduce the sample rate of the digital samples, e.g., from 8 GHz to 10 MHz, which greatly reduces the processing load of the optical ranging system 100. In some embodiments, the digital filter 121 has a programmable bandwidth, and the bandwidth of the digital filter 121 is adjusted (e.g., selected) based on the expected frequency of the beat signal, in order to allow the beat signal to pass through the digital filter 121 while rejecting out-of-band noises as much as possible.

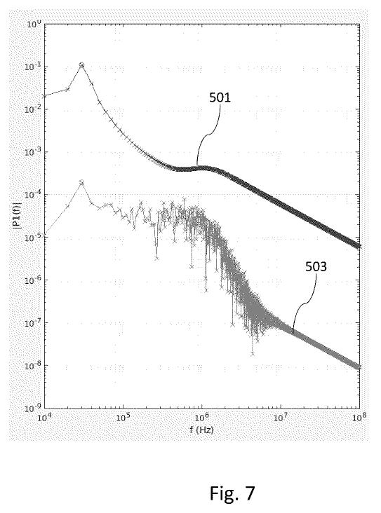

As described above, the output signal 122 of the digital filter 121 comprises a beat signal. The output signal 122 is sent to the frequency detector 123 to determine the frequency of the beat signal. In some embodiments, the frequency detector 123 performs a frequency analysis of the output signal 122 of the digital filter 121, and the frequency having the maximum amplitude in the frequency spectrum of the output signal 122 is chosen as the frequency of the beat signal. For example, the frequency detector 123 may perform a Fast Fourier Transform (FFT) of the output signal 122, and the frequency corresponding to the FFT frequency bin having the maximum amplitude is used as the frequency of the beat signal. FIG. 7 shows the frequency analysis performed by the optical ranging system 100, in an embodiment.

Referring temporarily to FIG. 7. In FIG. 7, the curve 503 shows the frequency components of the output signal 122 of the digital filter 121, generated by the frequency detector 123. The x-axis in FIG. 7 represents frequency, and the y-axis represents the amplitude of the frequency components at different frequencies. The data used for generating the curve 503 are generated by computer simulation of the optical ranging system 100. The computer simulation also simulates the optical transmission channel between the optical source in and the SPAD 115, as well as channel impairment such as random noise. For comparison purpose, the curve 501 in FIG. 7 illustrates the ideal (e.g., expected) frequency components of the output signal 122. It is seen from FIG. 7 that the peak frequencies of the curves 501 and 503 match, and therefore, the peak frequency components of the output signal 122, which corresponds to the beat frequency, can be reliably identified by the frequency analysis performed by the frequency detector 123.

Referring back to FIG. 1, once the frequency of the beat signal is determined, the distance between the optical ranging system 100 and the target is calculated by the range calculation circuit 125. The distance D between the optical ranging system 100 and the target may be calculated using the following equation:

$$D = \frac{{C}_{0} \vert Δ f \vert}{2 ( \frac{d f}{dt} )} \qquad ( 1 )$$

where C₀ is a constant that represents the speed of light, Δf is the beat frequency, and df/dt is the frequency shift of the chirp signal per unit of time, or equivalently, the gradient of the chirp signal 21A in FIG. 2.

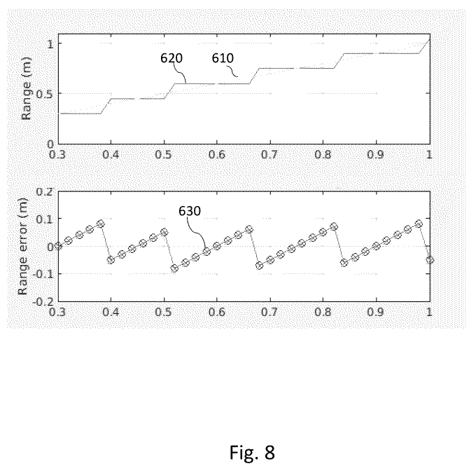

FIG. 8 illustrates the performance of the optical ranging system 100 of FIG. 1, in an embodiment. Computer simulation is performed to obtain the performance illustrated in FIG. 8. In the simulation, a VCSEL laser diode with 2.5 W peak power is used as the optical source 111. The chirp signal 110 sweeps from 100 MHz to 1 GHz with a chirp period of 0.1 ms. The reflectance of the target is 88%, and a 40 kLux ambient is simulated. FIG. 8 includes two subplots. The curve 620 in the top subplot shows the estimated distance of the target using the optical ranging system 100, where the x-axis indicates the true distance of the target, and the y-axis indicates the estimated distance of the target. For comparison, the curve 610 in the top subplot shows the expected distance (e.g., the true distance). The curve 630 in the bottom subplot shows the error in the estimated distance vs. the true distance of the target. It is seen from FIG. 8 that the estimated distance closely matches the true distance. The small error between the estimated distance and the true distance is caused by quantization error, in some embodiments. For example, the FFT transform performed by the frequency detector 123 has limited resolution in frequency domain, and all of the frequency components within an FFT frequency bin are assigned the same frequency corresponding to the FFT frequency bin.

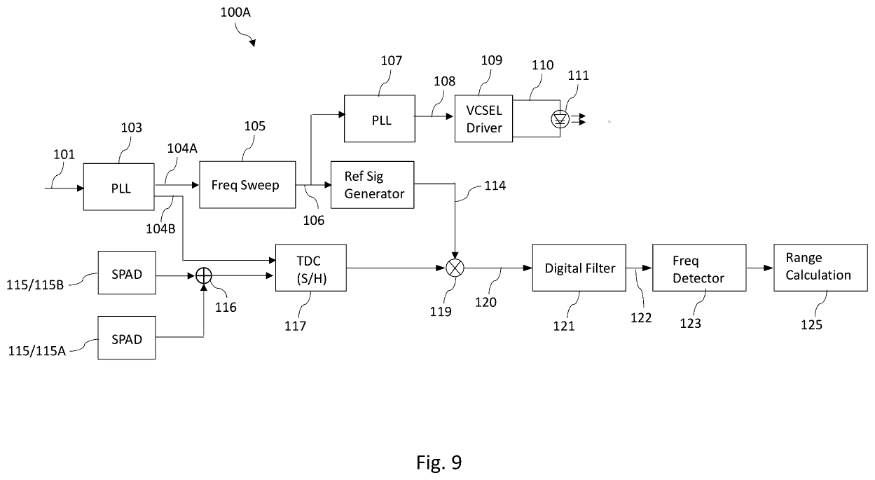

FIG. 9 illustrates a block diagram of an optical ranging system 100A, in another embodiment. The optical ranging system 100A is similar to the optical ranging system 100, but with a plurality of SPADs, such as a SPAD 115A and a SPAD 115B. The output of the SPAD 115A and the SPAD 115B are added together by an adder circuit 116 (e.g., a digital adder), and the output of the adder circuit 116 is sampled by the TDC 117. The number of SPADs in the optical ranging system 100A may be more than two, in which case the outputs of all of the SPADs are added together then sampled by the TDC 117.

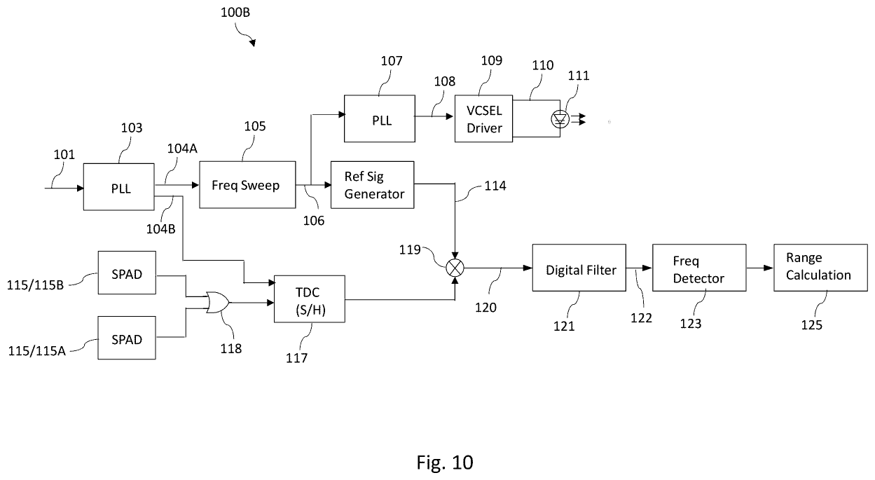

FIG. 10 illustrates a block diagram of an optical ranging system 100B, in yet another embodiment. The optical ranging system 100B is similar to the optical ranging system 100, but with a plurality of SPADs, such as a SPAD 115A and a SPAD 115B. The output of the SPAD 115A and the SPAD 115B are combined together by a logic OR gate 118, and the output of the logic OR gate is sampled by the TDC 117. The number of SPADs in the optical ranging system 100A may be more than two, in which case the outputs of all of the SPADs are combined together, e.g., using an OR tree, then sampled by the TDC 117.

In some embodiments, at least portions of the optical ranging system disclosed herein, such as 100, 100A, or 100B, may be integrated on a semiconductor substrate (e.g., silicon) to form an integrated circuit (IC) die, also referred to as a semiconductor die. For example, the IC die may include all processing blocks of the optical ranging system, or all processing blocks except certain components, such as the optical source in (e.g., the laser diode). In addition, some of the processing blocks of the optical ranging system, such as the digital filter 121, the frequency detector 123, and/or the range calculation circuit 125, may be implemented as software functional blocks running on, e.g., a processor, which processor may be integrated as part of the IC die of the optical ranging system, or may be a stand-alone processor connected to the IC die comprising other processing blocks of the optical ranging system.

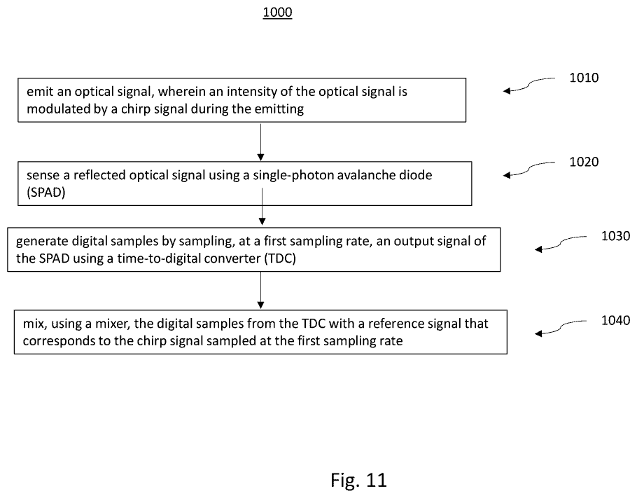

FIG. 11 illustrates a flow chart of a method 1000 of ranging using an optical ranging system, in some embodiments. It should be understood that the example method shown in FIG. 11 is merely an example of many possible example methods. One of ordinary skill in the art would recognize many variations, alternatives, and modifications. For example, various steps as illustrated in FIG. 11 may be added, removed, replaced, rearranged, or repeated.

Referring to FIG. 11 at block 1010, an optical signal is emitted, wherein an intensity of the optical signal is modulated by a chirp signal during the emitting. At block 1020, a reflected optical signal is sensed using a single-photon avalanche diode (SPAD). At block 1030, digital samples are generated by sampling, at a first sampling rate, an output signal of the SPAD using a time-to-digital converter (TDC). At block 1040, a mixer is used to mix the digital samples from the TDC with a reference signal that corresponds to the chirp signal sampled at the first sampling rate.

Embodiments may achieve advantages as described below. In the disclosed embodiments, the chirp signal 110 is used to modulate the intensity of the optical signal emitted by the optical source 111, instead of the frequency of the optical signal. As a result, the frequency components of the modulated optical signal are contained within a relatively narrow frequency band, which allows for a reasonable sampling rate (e.g., 8 GHz instead of 20 GHz) for sampling the output of the SPAD 115, and allows for a digital multiplier to be used as the mixer of the receiver path. As a result, an all-digital receiver path is achieved for the disclosed optical ranging systems. Expensive and bulky analogy optical interferometer is not needed in the disclosed optical ranging systems. Therefore, the disclosed optical ranging systems reduce component cost and is easy to integrate into IC dies.

Examples of the present invention are summarized here. Other examples can also be understood from the entirety of the specification and the claims filed herein.

Example 1. In an embodiment, an optical ranging system includes: a first phase-locked loop (PLL) configured to generate a first frequency signal and a second frequency signal; a second PLL configured to generate a third frequency signal based on a control signal, wherein the control signal is formed using the first frequency signal; an optical source coupled to the second PLL, wherein an intensity of an optical signal emitted by the optical source is configured to be modulated in accordance with the third frequency signal; a first single-photon avalanche diode (SPAD) configured to receive a reflected optical signal; a time-to-digital converter (TDC) coupled to the first SPAD, wherein the TDC is configured to generate digital samples by sampling an output signal of the first SPAD under control of the second frequency signal; a reference signal generator configured to generate a reference signal; and a mixer configured to mix the reference signal and the digital samples from the TDC.

Example 2. The optical ranging system of Example 1, further comprising: a digital filter coupled to the mixer and configured to filter an output signal of the mixer; and a frequency detector coupled to the digital filter and configured to detect a peak frequency in a spectrum of an output signal of the digital filter.

Example 3. The optical ranging system of Example 2, further comprising a range calculation circuit configured to calculate a distance between the optical ranging system and a target using the detected peak frequency.

Example 4. The optical ranging system of Example 2, wherein the first frequency signal has a first fixed frequency, the second frequency signal has a second fixed frequency, and the third frequency signal has a third frequency that changes linearly over a pre-determined period of time.

Example 5. The optical ranging system of Example 4, wherein the second fixed frequency is an integer multiple of the first fixed frequency.

Example 6. The optical ranging system of Example 4, further comprising a frequency sweep circuit coupled between the first PLL and the second PLL, wherein the frequency sweep circuit is configured to generate the control signal for the second PLL, wherein the control signal increases linearly over the pre-determined period of time.

Example 7. The optical ranging system of Example 6, wherein the reference signal generator is coupled between the frequency sweep circuit and the mixer.

Example 8. The optical ranging system of Example 4, further comprising a driver circuit for the optical source, wherein the driver circuit is coupled between the second PLL and the optical source, and is configured to generate a chirp signal in accordance with the third frequency signal, wherein the intensity of the optical source is modulated by the chirp signal.

Example 9. The optical ranging system of Example 8, wherein the digital samples from the TDC have a first sampling rate, wherein the reference signal corresponds to the chirp signal sampled at the first sampling rate.

Example 10. The optical ranging system of Example 2, further comprising: a second SPAD configured to receive the reflected optical signal; and an adder circuit coupled to the first SPAD and the second SPAD, and is configured to add the output signal of the first SPAD with an output signal of the second SPAD, wherein the TDC is configured to generate the digital samples by sampling an output signal of the adder circuit under control of the second frequency signal.

Example 11. The optical ranging system of Example 2, further comprising: a second SPAD configured to receive the reflected optical signal; and an OR gate, wherein a first input terminal of the OR gate is coupled to the first SPAD and a second input terminal of the OR gate is coupled to the second SPAD, wherein the TDC is configured to generate the digital samples by sampling an output signal of the OR gate under control of the second frequency signal.

Example 12. In an embodiment, an optical ranging system includes: an optical source configured to emit an optical signal, wherein an intensity of the optical signal is configured to be modulated by a chirp signal; a single-photon avalanche diode (SPAD) configured to receive a reflected optical signal; a time-to-digital converter (TDC) coupled to the SPAD, wherein the TDC is configured to generate first digital samples by sampling an output signal of the SPAD, wherein the first digital samples have a first sampling rate; a reference signal generator configured to generate a reference signal that corresponds to the chirp signal sampled at the first sampling rate; and a mixer configured to mix the reference signal and the first digital samples from the TDC.

Example 13. The optical ranging system of Example 12, further comprising: a digital filter coupled to an output of the mixer; and a frequency detection circuit coupled to an output of the digital filter and configured to detect a peak frequency component in an output signal of the digital filter.

Example 14. The optical ranging system of Example 13, further comprising a range calculation circuit configured to calculate a distance between the optical ranging system and a target using the detected peak frequency component.

Example 15. The optical ranging system of Example 13, wherein the optical source is a laser source having a fixed nominal wavelength for a laser signal emitted by the laser source, and the digital filter is a lower-pass filter.

Example 16. The optical ranging system of Example 13, wherein the mixer is a digital multiplier.

Example 17. In an embodiment, a method of ranging using an optical ranging system includes: emitting an optical signal, wherein an intensity of the optical signal is modulated by a chirp signal during the emitting; sensing a reflected optical signal using a single-photon avalanche diode (SPAD); generating digital samples by sampling, at a first sampling rate, an output signal of the SPAD using a time-to-digital converter (TDC); and mixing, using a mixer, the digital samples from the TDC with a reference signal that corresponds to the chirp signal sampled at the first sampling rate.

Example 18. The method of Example 17, further comprising: filtering an output signal of the mixer with a digital filter; performing a frequency analysis to determine a peak frequency of an output signal of the digital filter; and calculating a distance between the optical ranging system and a target using the detected peak frequency.

Example 19. The method of Example 18, wherein performing the frequency analysis comprises: performing a Fast Fourier Transform (FFT) for the output signal of the digital filter; and finding a frequency bin of the FFT that has a highest amplitude.

Example 20. The method of Example 17, wherein a wavelength of the optical signal is maintained at a fixed nominal value during the emitting.

While this invention has been described with reference to illustrative examples, this description is not intended to be construed in a limiting sense. Various modifications and combinations of the illustrative examples, as well as other examples of the invention, will be apparent to persons skilled in the art upon reference to the description. It is therefore intended that the appended claims encompass any such modifications or examples.

What is claimed is:

1. An optical ranging system comprising:
a first phase-locked loop (PLL) configured to generate a first frequency signal and a second frequency signal;
a second PLL configured to generate a third frequency signal based on a control signal, wherein the control signal is formed using the first frequency signal;
an optical source coupled to the second PLL, wherein an intensity of an optical signal emitted by the optical source is configured to be modulated in accordance with the third frequency signal;
a first single-photon avalanche diode (SPAD) configured to receive a reflected optical signal;
a time-to-digital converter (TDC) coupled to the first SPAD, wherein the TDC is configured to generate digital samples by sampling an output signal of the first SPAD under control of the second frequency signal;
a reference signal generator configured to generate a reference signal; and
a mixer configured to mix the reference signal and the digital samples from the TDC.

2. The optical ranging system of claim 1, further comprising:
a digital filter coupled to the mixer and configured to filter an output signal of the mixer; and
a frequency detector coupled to the digital filter and configured to detect a peak frequency in a spectrum of an output signal of the digital filter.

3. The optical ranging system of claim 2, further comprising a range calculation circuit configured to calculate a distance between the optical ranging system and a target using the detected peak frequency.

4. The optical ranging system of claim 2, wherein the first frequency signal has a first fixed frequency, the second frequency signal has a second fixed frequency, and the third frequency signal has a third frequency that changes linearly over a pre-determined period of time.

5. The optical ranging system of claim 4, wherein the second fixed frequency is an integer multiple of the first fixed frequency.

6. The optical ranging system of claim 4, further comprising a frequency sweep circuit coupled between the first PLL and the second PLL, wherein the frequency sweep circuit is configured to generate the control signal for the second PLL, wherein the control signal increases linearly over the pre-determined period of time.

7. The optical ranging system of claim 6, wherein the reference signal generator is coupled between the frequency sweep circuit and the mixer.

8. The optical ranging system of claim 4, further comprising a driver circuit for the optical source, wherein the driver circuit is coupled between the second PLL and the optical source, and is configured to generate a chirp signal in accordance with the third frequency signal, wherein the intensity of the optical source is modulated by the chirp signal.

9. The optical ranging system of claim 8, wherein the digital samples from the TDC have a first sampling rate, wherein the reference signal corresponds to the chirp signal sampled at the first sampling rate.

10. The optical ranging system of claim 2, further comprising:
a second SPAD configured to receive the reflected optical signal; and
an adder circuit coupled to the first SPAD and the second SPAD, and is configured to add the output signal of the first SPAD with an output signal of the second SPAD, wherein the TDC is configured to generate the digital samples by sampling an output signal of the adder circuit under control of the second frequency signal.

11. The optical ranging system of claim 2, further comprising:
a second SPAD configured to receive the reflected optical signal; and
an OR gate, wherein a first input terminal of the OR gate is coupled to the first SPAD and a second input terminal of the OR gate is coupled to the second SPAD, wherein the TDC is configured to generate the digital samples by sampling an output signal of the OR gate under control of the second frequency signal.

12. An optical ranging system comprising:
an optical source configured to emit an optical signal, wherein an intensity of the optical signal is configured to be modulated by a chirp signal;
a single-photon avalanche diode (SPAD) configured to receive a reflected optical signal;
a time-to-digital converter (TDC) coupled to the SPAD, wherein the TDC is configured to generate first digital samples by sampling an output signal of the SPAD, wherein the first digital samples have a first sampling rate;
a reference signal generator configured to generate a reference signal that corresponds to the chirp signal sampled at the first sampling rate; and
a mixer configured to mix the reference signal and the first digital samples from the TDC.

13. The optical ranging system of claim 12, further comprising:
a digital filter coupled to an output of the mixer; and
a frequency detection circuit coupled to an output of the digital filter and configured to detect a peak frequency component in an output signal of the digital filter.

14. The optical ranging system of claim 13, further comprising a range calculation circuit configured to calculate a distance between the optical ranging system and a target using the detected peak frequency component.

15. The optical ranging system of claim 13, wherein the optical source is a laser source having a fixed nominal wavelength for a laser signal emitted by the laser source, and the digital filter is a lower-pass filter.

16. The optical ranging system of claim 13, wherein the mixer is a digital multiplier.

17. A method of ranging using an optical ranging system, the method comprising:
emitting an optical signal, wherein an intensity of the optical signal is modulated by a chirp signal during the emitting;
sensing a reflected optical signal using a single-photon avalanche diode (SPAD);
generating digital samples by sampling, at a first sampling rate, an output signal of the SPAD using a time-to-digital converter (TDC); and
mixing, using a mixer, the digital samples from the TDC with a reference signal that corresponds to the chirp signal sampled at the first sampling rate.

18. The method of claim 17, further comprising:
filtering an output signal of the mixer with a digital filter;
performing a frequency analysis to determine a peak frequency of an output signal of the digital filter; and
calculating a distance between the optical ranging system and a target using the detected peak frequency.

19. The method of claim 18, wherein performing the frequency analysis comprises:
performing a Fast Fourier Transform (FFT) for the output signal of the digital filter; and
finding a frequency bin of the FFT that has a highest amplitude.

20. The method of claim 17, wherein a wavelength of the optical signal is maintained at a fixed nominal value during the emitting.
